(19) United States
(12) Patent Application Publication
(10) Pub. No.: US 2026/0270751 A1
(43) Pub. Date: Sep. 10, 2026

(54) TRANSMITTING PREDICTED BEAM REPORT BASED ON CONFIDENCE LEVEL OF PREDICTED BEAM

(71) Applicant: QUALCOMM Incorporated, San Diego, CA (US)

(72) Inventors: Mohamed Fouad Ahmed MARZBAN, San Diego, CA (US); Qiaoyu LI, Beijing (CN); Mahmoud TAHERZADEH BOROUJENI, San Diego, CA (US)

(21) Appl. No.: 19/157,942

(22) PCT Filed: Apr. 3, 2023
(86) PCT No.: PCT/CN2023/085861

§ 371 Date: Aug. 19, 2025

(51) Int. Cl. H04W 24/10; H04B 7/0417

(52) U.S. Cl. CPC H04W 24/10; H04B 7/0417

(57) ABSTRACT

Various aspects of the present disclosure generally relate to wireless communication. In some aspects, a user equipment (UE) may receive a beam report configuration. The UE may transmit, in accordance with the beam report configuration, a predicted beam report that includes an indication of at least one predicted beam and an indication of at least one confidence level that corresponds to the at least one predicted beam. The UE may transmit the predicted beam report based at least in part on the at least one confidence level. Numerous other aspects are described.

### FIELD OF THE DISCLOSURE

Aspects of the present disclosure generally relate to wireless communication and to techniques and apparatuses for transmitting a predicted beam report based on a confidence level of a predicted beam.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving a beam report configuration. The method includes transmitting, in accordance with the beam report configuration, a predicted beam report that includes an indication of at least one predicted beam and an indication of at least one confidence level that corresponds to the at least one predicted beam, wherein transmitting the predicted beam report includes transmitting the predicted beam report based at least in part on the at least one confidence level.

Another aspect provides a method for wireless communication by a network entity. The method includes outputting a beam report configuration. The method includes obtaining, in accordance with the beam report configuration, a predicted beam report that includes an indication of at least one predicted beam and an indication of at least one confidence level that corresponds to the at least one predicted beam, wherein obtaining the predicted beam report includes obtaining the predicted beam report based at least in part on the at least one confidence level.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture.

FIGS. 4A, 4B, 4C, and 4D depict aspects of data structures for a wireless communications network, in accordance with the present disclosure.

FIG. 5 is a diagram illustrating examples of beam management procedures, in accordance with the present disclosure.

FIG. 6 is a diagram illustrating an example of beam management, in accordance with the present disclosure.

FIG. 7 is a diagram illustrating an example associated with transmitting a predicted beam report based on at least one confidence level of at least one predicted beam, in accordance with the present disclosure.

FIG. 8 is a diagram illustrating examples of a plurality of predicted beams and associated confidence levels, in accordance with the present disclosure.

FIG. 9 is a diagram illustrating examples in which a first part of a predicted beam report includes an indication of a payload size of a second part of the predicted beam report, in accordance with the present disclosure.

FIG. 10 is a diagram illustrating an example in which a beam report configuration configures a payload size of the second part of the predicted beam report, in accordance with the present disclosure.

FIG. 11 is a diagram illustrating example involving a first predicted beam report and a second predicted beam report, in accordance with the present disclosure.

FIG. 12 shows a method for wireless communications by a UE, in accordance with the present disclosure.

FIG. 13 shows a method for wireless communications by a network entity, in accordance with the present disclosure.

FIG. 14 is a diagram illustrating an example of an implementation of code and circuitry for a communications device, in accordance with the present disclosure.

FIG. 15 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for transmitting a predicted beam report based on a confidence level of a predicted beam.

Artificial intelligence (AI) or machine learning (ML) may be used to generate predictions regarding beam management. For example, an AI/ML model may generate predictions of which predicted/potential beam would offer optimal performance for a user equipment (UE) and a network entity. Based on the AI/ML model-generated predictions, the network entity may select a beam for transmissions (e.g., for downlink and/or uplink transmissions).

The AI/ML-based predictive beam management may produce confidence levels (e.g., probabilities) associated with respective predicted beams. The confidence levels may be soft metrics that may be used to evaluate the quality of predictions. However, reporting the confidence levels (e.g., from the UE to the network entity) may involve additional overhead for transmission and processing of indications of the predicted beams and confidence levels. For example, the indications of the predicted beams and confidence levels can occupy additional time resources and/or frequency resources. Moreover, the UE and network entity may use compute and/or power resources to handle the confidence levels (e.g., to transmit, receive, and/or process indications of the confidence levels).

In some implementations provided herein, the UE may transmit a predicted beam report to the network entity. The predicted beam report may include an indication of at least one predicted beam and an indication of at least one confidence level corresponding to the at least one predicted beam. The UE may transmit the predicted beam report based on the at least one confidence level of the at least one predicted beam. For example, the predicted beams indicated in the predicted beam report may be the predicted beams having the highest confidence levels of all the predicted beams. For example, the predicted beams indicated in the predicted beam report may have confidence levels whose sum satisfies (e.g., exceeds) a threshold (e.g., a target confidence level threshold). The predicted beam report may be limited to those predicted beams and may exclude any remaining predicted beams having lower confidence levels than the predicted beams indicated in the predicted beam report.

Thus, implementations described herein may enable the network entity to obtain indications of predicted beams that are likely to be relevant to beam management (e.g., beam selection) without using additional overhead or resources to transmit indications of less relevant predicted beams. In some examples, the threshold may be configurable, which may provide control over the amount of overhead/resources involved in transmission and/or processing of the predicted beam report.

In some examples, the predicted beam report may include a first part transmitted via a first resource and a second part transmitted via a second resource. For example, the first part (which may include an indication of at least one predicted beam and corresponding confidence level) may indicate a payload size of the second part (which may or may not include an indication of at least one predicted beam and corresponding confidence level). Reporting the predicted beam report in multiple parts may inform the network entity of the quantity of predicted beams to be reported and, thus, address potential ambiguities that may arise regarding the size of the payload. In some examples, the first part may indicate that the second part of the predicted beam report is not to be transmitted, which may further reduce overhead associated with transmission of the report.

In some examples, the UE may receive, from the network entity, a beam report configuration that configures the first part of the predicted beam report and a payload size of the second part of the predicted beam report. For example, the network entity may configure the payload of the first part and second part before obtaining the first part of the predicted beam report (e.g., the second part of the payload may be preconfigured). In addition to addressing potential ambiguities, the beam report configuration that configures the first part and the second part may facilitate scheduling and minimize collisions with other predicted beam reports. In some examples, the first part may indicate that the second part of the predicted beam report is not to be transmitted, which may further reduce overhead associated with transmission of the report.

In some examples, the UE may transmit a first predicted beam report and a second predicted beam report to the network entity based on confidence levels of predicted beams indicated, respectively, in the first beam report and the second beam report. For example, the predicted beams indicated in the first and second predicted beam reports may have confidence levels whose sum satisfies (e.g., exceeds) a threshold (e.g., a target confidence level threshold). The first predicted beam report may indicate a payload size of the second predicted beam report, and the network entity may configure the payload size of the second predicted beam based on the first predicted beam report. The network entity may configure the payload size of the second predicted beam report such that overhead is reduced (e.g., such that the payload size of the second predicted beam report is limited based on the information (e.g., quantity of predicted beams and confidence levels) that is to be indicated in the second predicted beam report). In some examples, the first predicted beam report may indicate that the second predicted beam report is not to be transmitted, which may further reduce overhead associated with transmission of the predicted beam information.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

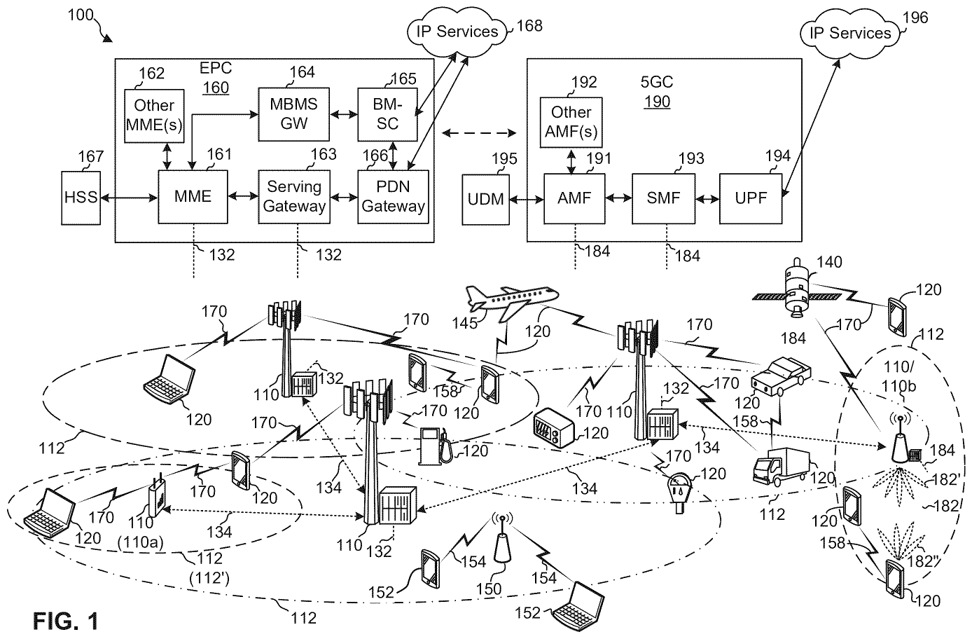

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IOT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

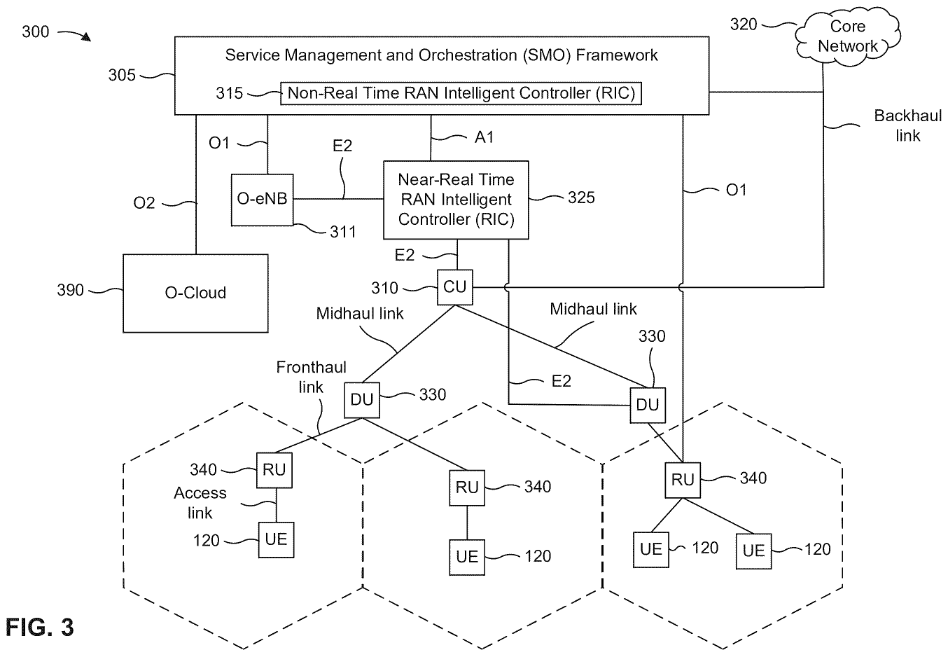

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN) may interface with the EPC 160 through first backhaul links 132 (e.g., an SI interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz 7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

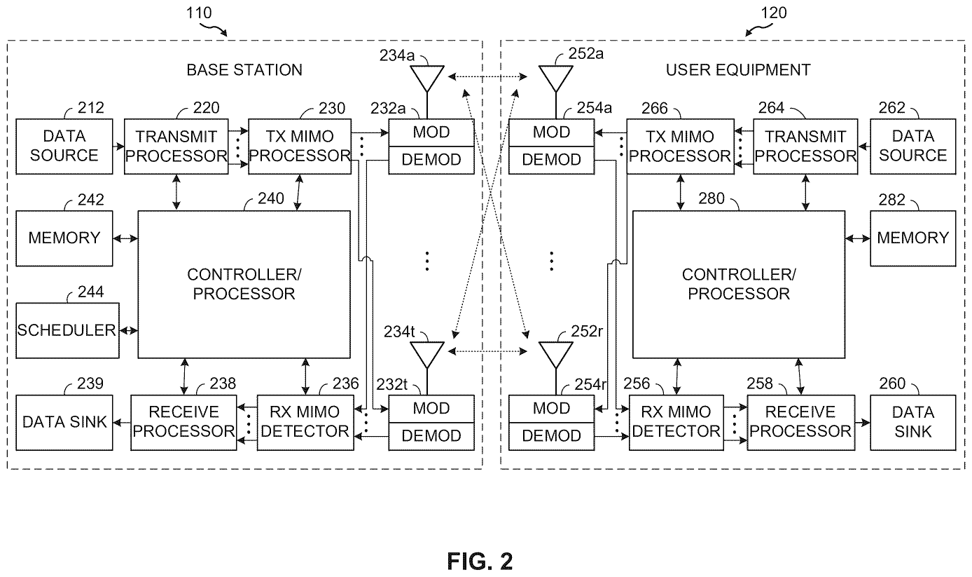

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for single-carrier frequency division multiplexing (SC-FDM)), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

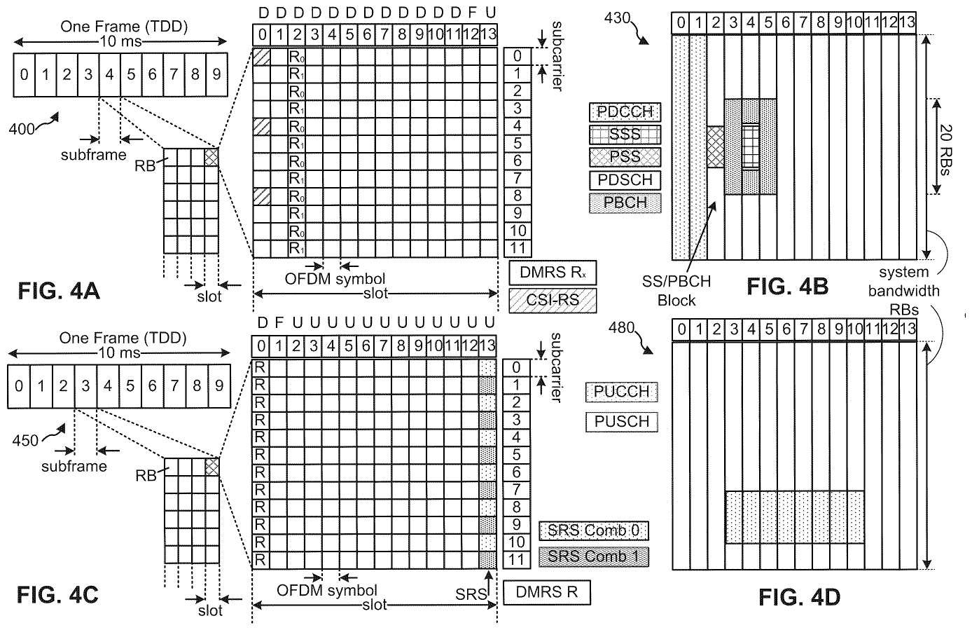

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where u is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSS) for a UE (e.g., UE 120). The RSs may include demodulation RSS (DMRSs) and/or CSI-RSs for channel estimation at the UE. The RSs may also include beam measurement RSS (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

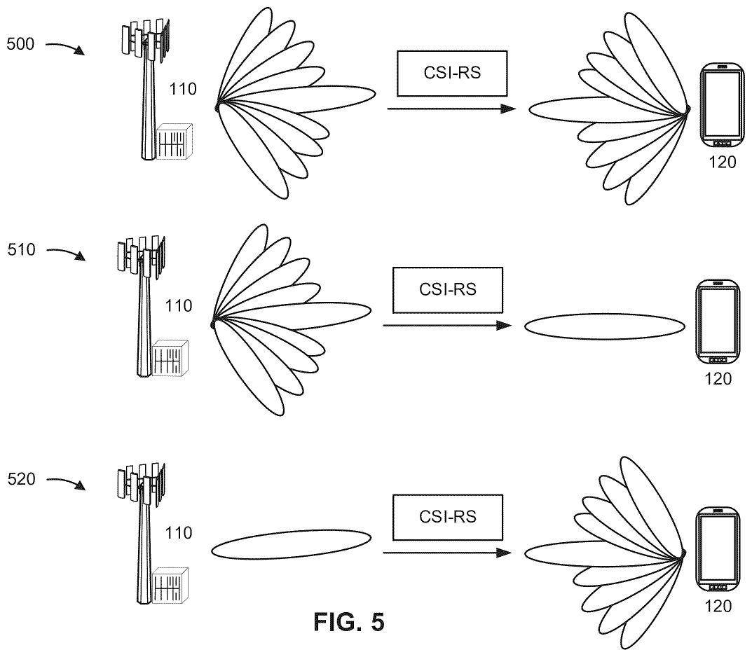

FIG. 5 is a diagram illustrating examples 500, 510, and 520 of beam management procedures, in accordance with the present disclosure. As shown in FIG. 5, examples 500, 510, and 520 include a UE 120 in communication with a BS 110 in a wireless network (e.g., wireless communications network 100). However, the devices shown in FIG. 5 are provided as examples, and the wireless network may support communication and beam management between other devices (e.g., between a UE 120 and a BS 110 or TRP, between a mobile termination node and a control node, between an IAB child node and an IAB parent node, and/or between a scheduled node and a scheduling node). In some aspects, the UE 120 and the BS 110 may be in a connected state (e.g., an RRC connected state).

As shown in FIG. 5, example 500 may include a BS 110 and a UE 120 communicating to perform beam management using CSI-RSs. Example 500 depicts a first beam management procedure (e.g., PI CSI-RS beam management). The first beam management procedure may be referred to as a beam selection procedure, an initial beam acquisition procedure, a beam sweeping procedure, a cell search procedure, and/or a beam search procedure. As shown in FIG. 5 and example 500, CSI-RSs may be configured to be transmitted from the BS 110 to the UE 120. The CSI-RSs may be configured to be periodic (e.g., using RRC signaling), semi-persistent (e.g., using MAC control element (MAC-CE) signaling), and/or aperiodic (e.g., using DCI).

The first beam management procedure may include the BS 110 performing beam sweeping over multiple transmit (Tx) beams. The BS 110 may transmit a CSI-RS using each transmit beam of the multiple Tx beams for beam management. To enable the UE 120 to perform receive (Rx) beam sweeping, the BS 110 may use a transmit beam to transmit (e.g., with repetitions) each CSI-RS at multiple times within the same RS resource set so that the UE 120 may sweep through receive beams in multiple transmission instances. For example, if the BS 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the BS 110, the UE 120 may perform beam sweeping through the receive beams of the UE 120. As a result, the first beam management procedure may enable the UE 120 to measure a CSI-RS on different transmit beams using different receive beams to support selection of BS 110 transmit beams/UE 120 receive beam(s) beam pair(s). The UE 120 may report the measurements to the BS 110 to enable the BS 110 to select one or more beam pair(s) for communication between the BS 110 and the UE 120. While example 500 has been described in connection with CSI-RSs, the first beam management process may also use SSBs for beam management in a similar manner as described above.

As shown in FIG. 5, example 510 may include a BS 110 and a UE 120 communicating to perform beam management using CSI-RSs. Example 510 depicts a second beam management procedure (e.g., P2 CSI-RS beam management). The second beam management procedure may be referred to as a beam refinement procedure, a BS beam refinement procedure, a TRP beam refinement procedure, and/or a transmit beam refinement procedure. As shown in FIG. 5 and example 510, CSI-RSs may be configured to be transmitted from the BS 110 to the UE 120. The CSI-RSs may be configured to be aperiodic (e.g., using DCI). The second beam management procedure may include the BS 110 performing beam sweeping over one or more transmit beams. The one or more transmit beams may be a subset of all transmit beams associated with the BS 110 (e.g., determined based at least in part on measurements reported by the UE 120 in connection with the first beam management procedure). The BS 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the BS 110 to select a best transmit beam based at least in part on measurements of the CSI-RSs (e.g., measured by the UE 120 using the single receive beam) reported by the UE 120.

As shown in FIG. 5, example 520 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 5 and example 520, one or more CSI-RSs may be configured to be transmitted from the BS 110 to the UE 120. The CSI-RSs may be configured to be aperiodic (e.g., using DCI). The third beam management process may include the BS 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the BS 110 may use a transmit beam to transmit (e.g., with repetitions) CSI-RS at multiple times within the same RS resource set so that UE 120 may sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the BS 110 and/or the UE 120 to select a best receive beam based at least in part on reported measurements received from the UE 120 (e.g., of the CSI-RS of the transmit beam using the one or more receive beams).

As indicated above, FIG. 5 is provided as an example of beam management procedures. Other examples of beam management procedures may differ from what is described with respect to FIG. 5. For example, the UE 120 and the BS 110 may perform the third beam management procedure before performing the second beam management procedure, and/or the UE 120 and the BS 110 may perform a similar beam management procedure to select a UE transmit beam.

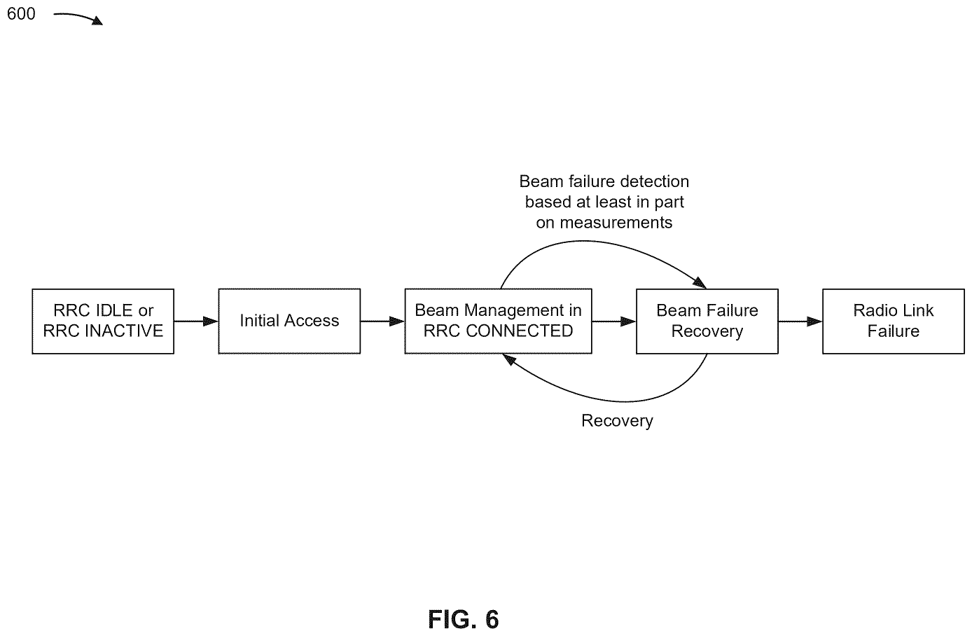

FIG. 6 is a diagram illustrating an example 600 of beam management, in accordance with the present disclosure. As shown, a UE may initially be in an RRC idle state or an RRC inactivate state. The UE may perform an initial access and may perform beam management after entering an RRC connected state as a result of the initial access. The UE may perform a beam failure detection (BFD), and the UE may perform a beam failure recovery (BFR) based at least in part on the BFD. When the BFR is not successful, the UE may declare a radio link failure (RLF).

In some examples, the initial access may involve SSB wide beam sweeping. In some examples, the initial access may involve contention-based random access (CBRA).

In some examples, the beam management may include P1, P2, and/or P3 beam management procedures, as described herein. In some examples, the beam management may include U1, U2 and/or U3 beam management procedures, which may be based on SRSs. The P1, P2, and/or P3 beam management procedures may be downlink beam management procedures, and the U1, U2 and/or U3 beam management procedures may be uplink beam management procedures. In some examples, the beam management may be based on Layer 1 reference signal received power (L1-RSRP) measurements. L1-RSRP measurements may be reported by the UE, or L1-RSRP measurements may be measured by the UE. The L1-RSRP measurements that are reported by the UE may be used to perform an inference at the network node. The L1-RSRP measurements that are measured by the UE may be used to perform an inference at the UE. In some examples, the beam management may be based on one or more transmission configuration indication (TCI) states of the beam(s).

In some examples, the beam management may involve one or more of Layer 1 signal-to-interference-plus-noise ratio (L1-SINR) reporting, overhead and latency reduction (e.g., based on beam updates for a component carrier group (CC-group) and/or faster uplink), or the like. In some examples, the beam management may involve further latency and efficient enhancements (e.g., unified TCI states, Layer 1 (L1)/Layer 2 (L2)—centric mobility, dynamic TCI updates, uplink multi-panel selection, maximum permissible exposure (MPE) mitigation, further beam management latency reduction, or the like), high-speed train (HST)/single frequency network (SFN) scenarios, beam management for multiple transmission and reception point (mTRP), or the like.

The UE may perform BFD and BFR for primary cell (Pcell) and/or primary and secondary cell (PScell) BFR. For example, the UE may perform BFD via BFD reference signals (BFD-RSs) and PDCCH block error rate (BLER), BFR based on contention-free random access (CFRA), or the like. Additionally, or alternatively, the UE may perform BFD and BFR for secondary cell (Scell). For example, the UE may transmit a link recovery request via a scheduling request (SR) and/or may perform BFD for Scell based on MAC-CE messaging.

As indicated above, FIG. 6 is provided as an example. Other examples may differ from what is described with regard to FIG. 6.

One or more AI/ML models may be used for facilitating wireless communication tasks. Lifecycle management of an AI/ML model may involve model training, model deployment, model inference, model monitoring, and model updating. The model training may involve AI/ML model training (e.g., offline training), validation, and/or testing, among other examples. AI/ML model training may also involve data preparation (e.g., data pre-processing, data cleaning, data formatting, and/or transformation, among other examples) based on training data delivered by the data collection function. The model deployment may include deploying the AI/ML model (e.g., at a UE or a network node).

The model inference may involve providing inference data as input data to the AI/ML model and obtaining an AI/ML model inference output (e.g., predictions, classifications, estimations, and/or decisions, among other examples). In some cases, the model inference may involve providing model performance feedback to the model training function. The model inference may also involve performing data preparation (e.g., data pre-processing, data cleaning, data formatting, and/or transformation, among other examples) based on inference data.

The model monitoring may involve monitoring the AI/ML model for model performance (e.g., how often, and/or to what extent, predictions generated by the AI/ML model are correct). For example, poor performance by an AI/ML model (e.g., if the accuracies of the predictions of the AI/ML model fall below a threshold) may trigger a fallback to a non-AI/ML model. Model updating may involve retraining the AI/ML model or switching to a different AI/ML model. In some examples, model monitoring may trigger model updating.

AI/ML-based predictive beam management may involve beam management using AI/ML. One problem with traditional beam management procedures is that beam qualities/failures are identified via measurements, which may require power/overhead to achieve good performance. Further, beam accuracy may be limited due to restrictions on power/overhead, and latency/throughput may be impacted by beam resuming efforts. AI/ML-based predictive beam management may provide predictive beam management in a spatial domain (SD), time domain (TD), and/or frequency domain (FD), and may result in latency and overhead reduction and/or beam selection accuracy improvement.

For AI/ML-based beam management, a first case of beam management and a second case of beam management may be supported for characterization and baseline performance evaluations. In the first case, an SD downlink beam prediction for a Set A of beams may be based at least in part on measurement results of a Set B of beams. In the second case, a temporal downlink beam prediction for a Set A of beams may be based at least in part on historic measurement results of a Set B of beams. Thus, Set A may correspond to an output of the ML model, and Set B may correspond to an input of the model. Beams in Set A and beams in Set B may be in the same frequency range.

For the first case, a first alternative and a second alternative may be defined. In the first alternative, the beams in Set B may be a subset of the beams in Set A. A quantity of beams in Set A and a quantity of beams in Set B may be defined. The beams in Set B may be determined from the beams in Set A based at least in part on a fixed pattern or a random pattern. In the second alternative, the beams in Set A may be different than the beams in Set B (e.g., the beams in set B may not be a subset of the beams in Set A). For example, the beams in Set A may be associated with narrow beams, and the beams in Set B may be associated with wide beams. A quantity of beams in Set A and a quantity of beams in Set B may be defined. A quasi-co-location (QCL) relation may be defined between beams in Set A and beams in Set B. With respect to the first alternative and the second alternative, Set A may be associated with a downlink beam prediction and Set B may be associated with a downlink beam measurement. A codebook construction for Set A and a codebook construction for Set B may be defined.

For a UE-side AI/ML model (e.g., an AI/ML model deployed on the UE), L1 signaling may be used to report AI/ML model inference information to the network node. For example, in the first case, the L1 signaling may report the beam(s) based on the output of the AI/ML model inference and/or the L1-RSRP corresponding to the beam(s). In the second case, the L1 signaling may be used to report the beam(s) of N future time instance(s) based on the output of the AI/ML model inference, the L1-RSRP corresponding to the beam(s), and/or explicit or implicit information regarding one or more timestamps corresponding to the reported beam(s).

At least three alternatives may be defined for the monitoring a UE-side AI/ML model with potential down-selection. The alternatives may apply to the first case and the second case. The first alternative may involve UE-side model monitoring. For example, the UE may monitor the performance metric(s) of the AI/ML model and, based on the monitoring, determine whether to perform an operation (e.g., model selection, model activation, model deactivation, model switching, fallback, or the like). The second alternative may involve network-side model monitoring. For example, the network may monitor the performance metric(s) of the AI/ML model and, based on the monitoring, determine whether to perform an operation (e.g., model selection, model activation, model deactivation, model switching, fallback, or the like). The third alternative may involve hybrid model monitoring. For example, the UE may monitor the performance metric(s) of the AI/ML model, and the network may, based on the monitoring, determine whether to perform an operation (e.g., model selection, model activation, model deactivation, model switching, fallback, or the like).

In the first case and/or the second case, for a network-side AI/ML model, the network may perform model monitoring (e.g., “network-side model monitoring”). For example, the network may monitor the performance metric(s) of the AI/ML model and, based on the monitoring, determine whether to perform an operation (e.g., model selection, model activation, model deactivation, model switching, fallback, or the like). In this example, beam measurements may occur and a report for model monitoring may be generated.

In the first case and/or the second case, for a network-side AI/ML model, L1 beam reporting may be enhanced for AI/ML model inference. For example, the UE may report the measurement results of more than four beams in one reporting instance. Other L1 reporting enhancements may also be implemented.

AI/ML-based predictive beam management may produce confidence levels (e.g., probabilities) associated with respective predicted beams. However, reporting the confidence levels (e.g., from the UE to the network node) may involve additional overhead that is used to transmit indications of the confidence levels. The additional overhead can occupy time and/or frequency resources and may thereby contribute to latency. Moreover, the UE and network node may use compute and/or power resources to handle the confidence levels (e.g., to transmit, receive, and/or process the confidence levels).

One approach to mitigate the overhead and resource utilization issues introduced by the confidence levels is for the UE to report only one predicted beam and the associated confidence level (e.g., the predicted beam with the highest associated confidence level of all the predicted beams). However, a report that contains only one predicted beam may exclude information that would, if included in the report, improve the performance of the predicted beams. For example, the report would exclude information regarding the other predicted beams. Thus, including only one predicted beam may degrade beam prediction performance. One approach to avoiding degraded beam prediction performance is for the UE to report all of the predicted beams and associated confidence levels. While this approach may help ensure that the soft information (e.g., the confidence levels) is communicated to the network, the report would be associated with high overhead, as discussed above.

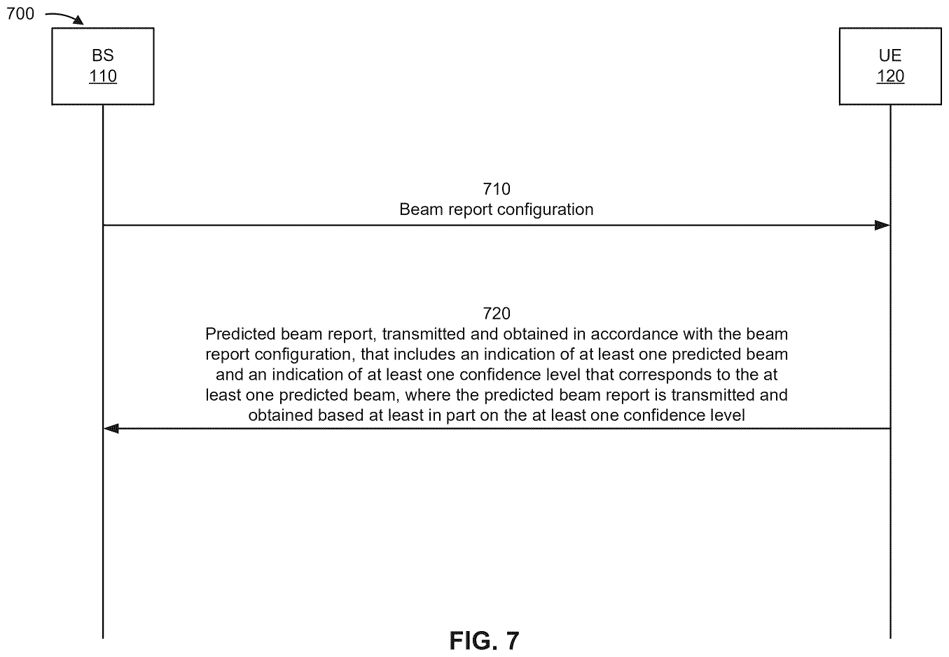

FIG. 7 is a diagram illustrating an example 700 associated with transmitting a predicted beam report based on at least one confidence level of at least one predicted beam, in accordance with the present disclosure. As shown in FIG. 7, a BS 110 and a UE 120 may communicate with one another.

As shown by reference number 710, the BS 110 may output, and the UE 120 may receive, a beam report configuration. The beam report configuration (and/or other configurations discussed herein) may be configured via RRC, semi-statically updated via MAC-CE, or dynamically activated or deactivated via DCI.

As shown by reference number 720, the UE 120 may transmit, and the BS 110 may obtain, in accordance with the beam report configuration, a predicted beam report (e.g., a channel state information (CSI) report) that includes an indication of at least one predicted beam and an indication of at least one confidence level that corresponds to the at least one predicted beam. The UE 120 may transmit, and the BS 110 may obtain, the predicted beam report based at least in part on the at least one confidence level. For example, the UE 120 may include the indication of the at least one predicted beam in the predicted beam report based on the at least one confidence level. In some examples, the UE 120 may exclude indications of other predicted beams from the predicted beam report based on other confidence levels of the other predicted beams.

A confidence level may indicate a probability (e.g., chance, certainty, or the like) that a predicted beam will be selected from among one or more predicted beams. For example, the confidence level may indicate, relative to any other predicted beams, a predicted signal strength for the predicted beam. Confidence levels may be soft metrics that may be used to evaluate the quality of predictions. Selection of a predicted beam that has a corresponding confidence level may be more reliable (e.g., less noisy) than hard-decision beam prediction and selection (e.g., selection of a beam without an associated confidence level).

The UE 120 may generate the predicted beam and the confidence level using an AI/ML model, as described above, deployed at the UE 120. The UE 120 may generate the predicted beam report (e.g., determine the content of the predicted beam report) based on output of the AI/ML model. For example, the AI/ML model may output the predicted beam and the confidence level, and the UE 120 may include the predicted beam and the confidence level in the predicted beam report.

Transmitting and obtaining the predicted beam report based on the confidence level may enable the predicted beam report to include indications of the predicted beams that are likely to be selected to carry uplink and/or downlink transmissions (e.g., have higher associated confidence levels) and/or exclude indications of any predicted beams that are unlikely to be selected to carry uplink and/or downlink transmissions (e.g., have lower associated confidence levels). Thus, the predicted beam report may conserve additional overhead and resources by excluding indications of the less relevant predicted beams while indicating the predicted beams that may be more relevant for beam selection.

As indicated above, FIG. 7 is provided as an example. Other examples may differ from what is described with respect to FIG. 7.

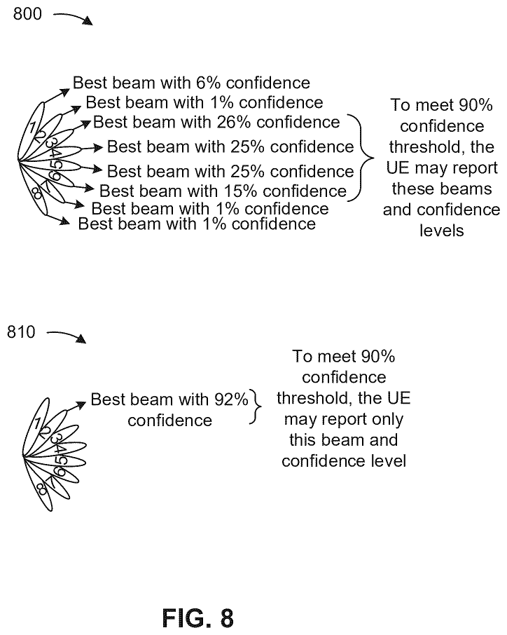

FIG. 8 is a diagram illustrating example 800 of a plurality of predicted beams and associated confidence levels and example 810 of a plurality of predicted beams and associated confidence levels, in accordance with the present disclosure. The plurality of predicted beams and confidence levels may be generated by an AI/ML model, as described above, deployed at the UE 120. In example 800 and example 810, the UE 120 may determine which predicted beams to include in the predicted beam report. The quantity of predicted beams indicated in a given predicted beam report may, depending on the confidence levels, vary across predicted beam reports. For example, the quantity of predicted beams indicated in the predicted beam report in example 800 may differ from the quantity of predicted beams indicated in the predicted beam report in example 810.

In example 800, predicted beam 3 has the highest confidence level (26%) of predicted beams 1-8. However, if the UE 120 were to report only predicted beam 3 (e.g., in the interest of conserving overhead), then the predicted beam report would exclude predicted beam 4 (confidence level of 25%) and predicted beam 5 (confidence level of 25%). As a result, although the confidence levels of predicted beam 4 and predicted beam 5 are relatively close (here, 1%) to the confidence level of predicted beam 3, excluding the indications of predicted beam 4 and predicted beam 5 from the predicted beam report may cause the BS 110 to overlook predicted beam 4 and predicted beam 5 (e.g., not consider predicted beam 4 or predicted beam 5 for selection), even if predicted beam 4 or predicted beam 5 would, if ultimately selected, provide a higher-quality beam than predicted beam 3. Thus, in example 800, rather than reporting only predicted beam 3, the UE 120 may report the three or four predicted beams having the highest respective confidence levels of predicted beams 1-8. For example, the UE 120 may report predicted beam 3, predicted beam 4, and predicted beam 5—which may enable the BS 110 to consider the relevant predicted beams for selection—and exclude the remaining predicted beams from the report—which may conserve overhead.

In example 810, predicted beam 2 has the highest confidence level (92%) of predicted beams 1-8, and predicted beams 1 and 3-8 have respective confidence levels that sum to the remaining 8%. In this case, indicating any predicted beams other than predicted beam 2 (e.g., in the interest of providing BS 110 with beam selection information) in the predicted beam report may introduce an inordinate amount of overhead considering the comparatively low confidence levels of predicted beams 1 and 3-8. Thus, in example 810, rather than reporting multiple predicted beams, the UE 120 may report the only predicted beam 2 (and the associated confidence level of 92%), which may conserve overhead.

In some examples, the quantity of predicted beams indicated in the predicted beam report may be based at least in part on whether a total of the corresponding confidence levels satisfies a threshold. For example, the quantity of predicted beams and corresponding confidence levels indicated in the report may depend on the total of the confidence levels (e.g., the sum confidence, sum probabilities, or the like) indicated in the predicted beam report meeting a target confidence level threshold.

For example, the network (e.g., BS 110) may configure the UE 120 to report identifiers of the predicted beams having the highest confidence levels whose total meets a threshold. In some examples, the UE 120 may also report the reference signal received powers (RSRPs) and/or signal-to-interference-plus-noise ratios (SINRs) of the predicted beams. The network may configure the UE 120 to report the top K predicted beams (e.g., beam indices or RSRPs) whose combined confidence (e.g., sum probabilities) is above a threshold (e.g., 90%). For example, if the threshold is set to 90%, then in example 800 the UE 120 may report predicted beams 3-6 (excluding predicted beams 1, 2, 7, and 8), and in example 810, the UE 120 may report only predicted beam 2.

Including a variable quantity of beams and corresponding confidence levels in each predicted beam report may reduce reporting overhead while ensuring that sufficient soft beam prediction information is associated with each predicted beam report and, thus, that information regarding the predicted beam(s) that are more likely to be selected is reported to the network.

In some examples, the threshold may be configurable (e.g., adjustable). For example, the network may configure the threshold as any suitable percentage (e.g., 85%, 90%, 95%, or the like). The configurability of the threshold may provide control over the amount of overhead/resources involved in transmission and/or processing of the predicted beam report. For example, increasing the threshold may increase the quantity of predicted beams reported to the BS 110. Decreasing the threshold may decrease the overhead involved in transporting the predicted beam report.

As indicated above, FIG. 8 is provided as an example. Other examples may differ from what is described with respect to FIG. 8.

In some examples, the BS 110 may configure the UE 120, via the beam report configuration, to report a first part of the predicted beam report via a first resource and a second part of the predicted beam report via a second resource (e.g., the beam prediction report may be divided into at least two parts). Accordingly, the UE 120 may transmit, and the BS 110 may obtain, the first part of the predicted beam report via the first resource and transmit the second part of the predicted beam report via the second resource. Reporting the predicted beam report in multiple parts may inform the BS 110 of the quantity of predicted beams to be reported and, thus, address potential ambiguities that may arise regarding the size of the payload.

In some examples, the first part of the predicted beam report includes an indication of a payload size of the second part of the predicted beam report. For example, the network may configure the UE 120 to report the top K predicted beams whose combined confidence satisfies the threshold in a two-part predicted beam report (e.g., a two-part CSI report). The indication of the payload size of the second part may be a proposed payload size.

The beam report configuration may configure a payload size of the first part of the predicted beam report. For example, the first part of the predicted beam report may have a payload size that is fixed according to network configurations (e.g., CSI report settings). The UE 120 may be configured to report the top N predicted beams in the predicted beam report (where N is less than K) and the corresponding confidence levels. Configuring the payload size of the first part of the predicted beam report in the beam report configuration (e.g., configuring the payload size as a fixed configuration) may facilitate scheduling and minimize collisions with other transmissions (e.g., other reports).

The first part of the predicted beam report may indicate whether the second part of the predicted beam report is to be transmitted. For example, if N equals K, then all of the predicted beams to be transmitted may be transmitted in the first part, and the UE 120 may refrain from transmitting the second part. The first part may indicate whether the UE 120 is to transmit (and whether the BS 110 is to obtain) the second part explicitly or implicitly. Thus, the BS 110 may be informed (e.g., explicitly or implicitly) whether the second part is to be transmitted.

For example, the first part of the predicted beam report may include an explicit indication that the UE 120 is to transmit (and the BS 110 is to obtain) the second part of the predicted beam report (e.g., whether the second part is to be reported). For example, the explicit indication may be a 1-bit indicator included in the first part (e.g., where “0” indicates that the second part is to be transmitted and “1” indicates that the second part is not to be transmitted, or where “0” indicates that the second part is not to be transmitted and “1” indicates that the second part is to be transmitted).

The first part may implicitly indicate that the UE is to transmit the second part based at least in part on a total of any confidence levels that are indicated in the first part of the predicted beam report not satisfying a threshold. For example, the BS 110 may obtain the first part, determine that the confidence levels indicated in the first part do not sum to the threshold, and determine that the second part is to be transmitted. Or, the BS 110 may obtain the first part, determine that the confidence levels indicated in the first part meet or exceed the threshold, and determine that the second part is not to be transmitted.

The first part may indicate configuration details of the second part. For example, as discussed above, the first part may indicate the payload size of the second part. In some examples, the indication of the payload size of the second part may include an indication of a quantity of one or more predicted beams (and the associated confidence levels) that are to be indicated in the second part. Thus, the BS 110 may be informed regarding the indication of the payload size of the second part.

In some examples, the two-part beam prediction report may be configured and/or multiplexed on one or more PUSCH resources. Configuring the beam prediction report on the PUSCH resource(s) may enable the UE 120 to transmit the beam prediction report without excessive overhead, because PUSCH may allow for variable payloads.

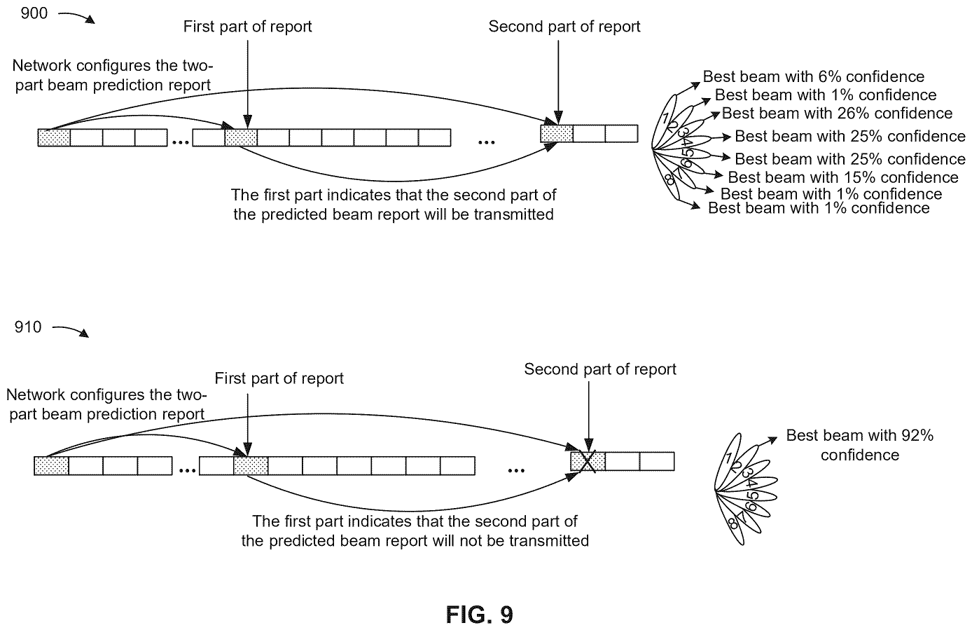

FIG. 9 is a diagram illustrating example 900 in which a first part of a predicted beam report includes an indication of a payload size of a second part of the predicted beam report and example 910 in which a first part of a predicted beam report includes an indication of a payload size of a second part of the predicted beam report, in accordance with the present disclosure. Example 900 and example 910 illustrate how the UE 120 may transmit the second part based at least in part on whether a total of one or more confidence levels that are indicated in the first part of the predicted beam report satisfies a threshold.

Example 900 involves example 800. In example 900, the UE 120 may report the top two predicted beams and associated confidence levels in the first part of the predicted beam report (e.g., N=2). As shown, because the total of the confidence levels of the top two predicted beams is 51%, which is less than the 90% threshold, the first part may indicate that the second part of the predicted beam report will be transmitted. In some examples, the UE 120 may also indicate in the first part that the second part will report two additional predicted beams to meet the 90% threshold (because the total of the confidence levels of the top four predicted beams is 91%, which is greater than the 90% threshold).

Example 910 involves example 810. In example 910, the UE 120 may report the top two predicted beams and associated confidence levels in the first part of the predicted beam report (e.g., N=2). As shown, because the total of the confidence levels of the top two predicted beams is greater than 90% (e.g., 94%, if the second-highest confidence level is 2%), which is greater than the 90% threshold, the first part may indicate that the second part of the predicted beam report will not be transmitted.

As indicated above, FIG. 9 is provided as an example. Other examples may differ from what is described with respect to FIG. 9.

In some examples, the beam report configuration may configure a payload size of the second part of the predicted beam report. For example, the network may configure the UE 120 to report the top N predicted beams in the first part and the remaining K-N predicted beams in the second part. Thus, the second part may have a preconfigured or fixed payload size. In some examples, the UE 120 may also report the L1-RSRPs and/or L1-SINRs of the predicted beams. Configuring the payload size of the second part in the beam report configuration may facilitate scheduling and minimize collisions with other transmissions (e.g., other reports) because the BS 110 may configure the payload size well in advance of when the second part is scheduled for transmission (e.g., the BS 110 may configure the payload size of the second part before obtaining the first part).

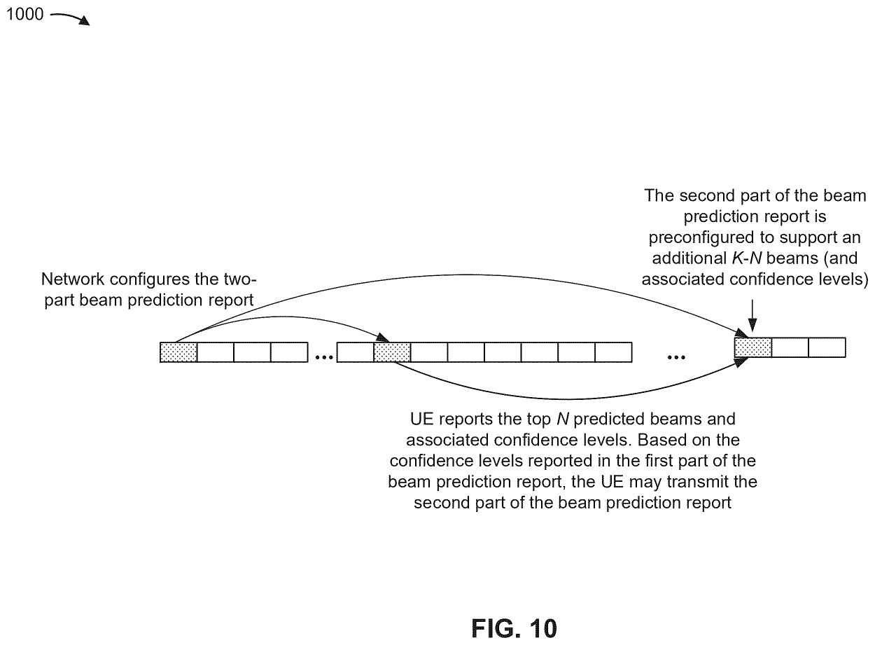

FIG. 10 is a diagram illustrating example 1000 in which the beam report configuration configures a payload size of the second part of the predicted beam report, in accordance with the present disclosure. In example 1000, the UE 120 may be configured to report the top N predicted beams in the first part of the predicted beam report. The UE 120 may transmit the second part based at least in part on whether a total of one or more confidence levels that are indicated in the first part of the predicted beam report satisfies a threshold. For example, if the total of the confidence levels does not satisfy the threshold, the UE 120 may transmit the second part. If the total of the confidence levels satisfies the threshold, the UE 120 may refrain from transmitting the second part.

As indicated above, FIG. 10 is provided as an example. Other examples may differ from what is described with respect to FIG. 10.

In some examples, the beam report configuration of the first part of the predicted beam report and the second part of the predicted beam report may include an indication of a first priority associated with the first part and an indication of a second priority associated with the second part. The UE 120 may transmit the first part in accordance with the first priority and the second part in accordance with the second priority.

By assigning a priority to the interference report, the network node may help the UE 120 to resolve conflicts when the interference report collides with other reports (e.g., HARQ-ACK, PUSCH, CSI resources, or the like). In some examples, the priority of the interference report may help the UE 120 decide whether to drop the interference report or to multiplex the interference report with other uplink communications (e.g., reports).

In some examples, the BS 110 may output, and the UE 120 may receive, an indication of one or more priority rules. The priority rule(s) may indicate how to resolve collisions, based at least in part on the first priority, between the first part of the predicted beam report and another report (e.g., a channel state or other uplink report). Additionally, or alternatively, the priority rule(s) may indicate how to resolve collisions, based at least in part on the second priority, between the second part of the predicted beam report and another report (e.g., a channel state or other uplink report). The priority rule(s) may help to ensure that the BS 110 and the UE 120 agree regarding the outcome of a collision.

In some examples, the UE 120 may transmit, and the BS 110 may obtain, the first part of the predicted beam report based at least in part on a first quantization table and the second part of the predicted beam report based at least in part on the second quantization table. A quantization table may indicate a quantity of quantization bits to be allocated for a part of a predicted beam report. For example, the predicted beam report may carry the quantity of quantization bits to indicate the predicted beams and associated confidence levels. In some examples, the quantization tables may be defined in a standards specification. Transmitting and obtaining the first and second parts based on the first and second quantization tables may enable the BS 110 to control the quantity of quantization bits that is allocated for the predicted beam report, which may further reduce the overhead involved in transmitted the predicted beam report.

For example, the first quantization table may define a first quantity of quantization bits, and the second quantization table may define a second quantity of quantization bits. For instance, the UE 120 may transmit, and the BS 110 may obtain, the first part of the predicted beam report using the first quantity of quantization bits and the second part of the predicted beam report using the second quantity of quantization bits. For example, the first quantity may be greater than the second quantity (e.g., the first part may be transmitted using more quantization bits than the second part).

Transmitting and obtaining the first and second parts using the first and second quantities of quantization bits, respectively, may allow the first and second parts to use different quantities of quantization bits. For example, the BS 110 may configure the UE 120 to use more quantization bits to transmit the first part, which may carry indications of predicted beams with higher confidence levels than the confidence levels of the predicted beams indicated in the second part.

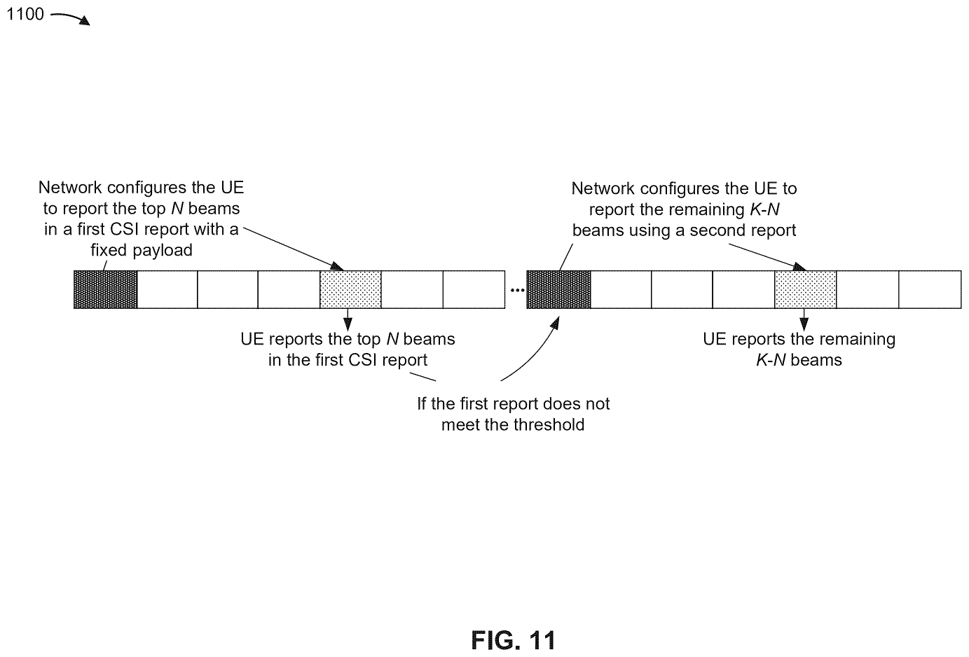

FIG. 11 is a diagram illustrating example 1100 involving a first predicted beam report and a second predicted beam report, in accordance with the present disclosure. As shown, in some examples, the BS 110 may output, and the UE 120 may receive, a first beam report configuration and a second beam report configuration. The UE 120 may transmit, and the BS 110 may obtain, in accordance with the first beam report configuration, a first predicted beam report (e.g., a CSI report) and, in accordance with the second beam report configuration, a second predicted beam report. The first predicted beam report may include an indication of at least one first predicted beam and an indication of at least one first confidence level that corresponds to the at least one first predicted beam. The second predicted beam report may include an indication of at least one second predicted beam and an indication of at least one second confidence level that corresponds to the at least one second predicted beam.

The network entity may configure the payload size of the second predicted beam report such that overhead is reduced. For example, the payload size of the second predicted beam report may be configured (e.g., limited) based on the information (e.g., quantity of predicted beams and confidence levels) that is to be indicated in the second predicted beam report.

The UE 120 may be configured to report identifiers of the top predicted beams (e.g., the predicted beams having the highest associated confidence levels) to meet the threshold across at least two predicted beam reports. In some examples, the UE 120 may include, in the first predicted beams report and/or the second predicted beam report, one or more of the L1-RSRPs of the top predicted beams or the L1-SINRs of the top predicted beams.

In some examples, the first beam report configuration may configure a payload size of the first predicted beam report. For example, the BS 110 may configure the UE 120 to report the top N beams in the first predicted beam report, which may have a fixed payload.

The UE 120 may receive the second beam report configuration based at least in part on whether a total of one or more confidence levels that are indicated in the first predicted beam report satisfies a threshold. For example, if the total of the confidence levels does not satisfy the threshold, the UE 120 may transmit the second predicted beam report, which may include the remaining top K beams to be reported. If the total of the confidence levels satisfies the threshold, the UE 120 may refrain from transmitting the second predicted beam report, which may further reduce overhead associated with transmission of the predicted beam information.

In some examples, the first predicted beam report includes an indication of a payload size and/or structure of the second predicted beam report. For example, the indication of the payload size of the second predicted beam report includes an indication of a quantity of the at least one predicted beam, which are to be indicated in the second predicted beam report. The predicted beams indicated in the second predicted beam report may have associated confidence levels that, when summed with the confidence levels associated with the predicted beams indicated in the first predicted beam report, satisfy a threshold (e.g., 90%). The UE 120 may wait for the BS 110 to configure the second predicted beam report before reporting the remaining predicted beams that meet the threshold.

As indicated above, FIG. 11 is provided as an example. Other examples may differ from what is described with respect to FIG. 11.

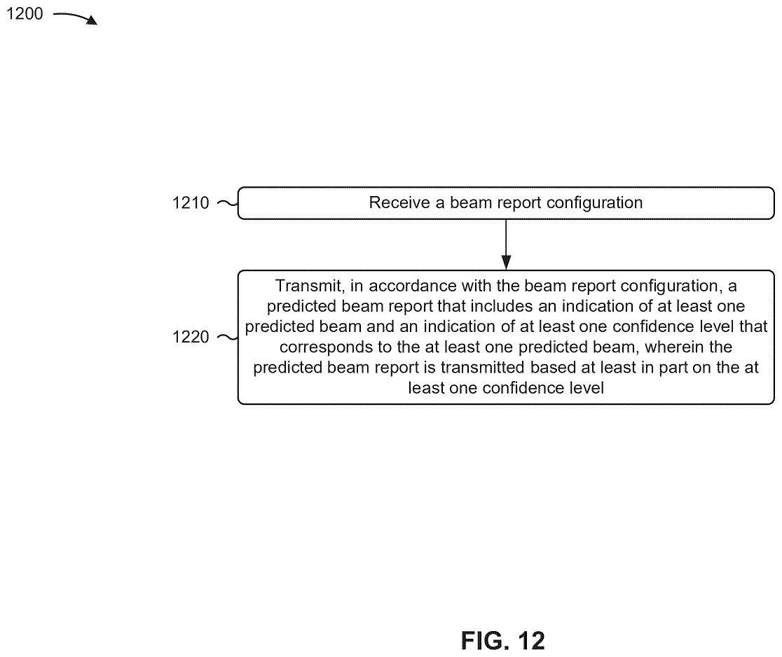

FIG. 12 shows a method 1200 for wireless communications by a UE, such as UE 120.

Method 1200 begins at 1210 with receiving a beam report configuration.

Method 1200 then proceeds to step 1220 with transmitting, in accordance with the beam report configuration, a predicted beam report that includes an indication of at least one predicted beam and an indication of at least one confidence level that corresponds to the at least one predicted beam, wherein transmitting the predicted beam report includes transmitting the predicted beam report based at least in part on the at least one confidence level.

In one aspect, the confidence level indicates a probability that the at least one predicted beam will be selected from among one or more predicted beams.

In one aspect, a quantity of one or more predicted beams, including the at least one predicted beam, indicated in the predicted beam report is based at least in part on whether a total of one or more confidence levels, including the at least one confidence level, satisfies a threshold.

In one aspect, the threshold is configurable.

In one aspect, the beam report configuration configures the UE to report a first part of the predicted beam report via a first resource and a second part of the predicted beam report via a second resource, and transmitting the predicted beam report includes transmitting the first part of the predicted beam report via the first resource, and transmitting the second part of the predicted beam report via the second resource.

In one aspect, the first part of the predicted beam report includes an indication of a payload size of the second part of the predicted beam report.

In one aspect, the beam report configuration configures a payload size of the first part of the predicted beam report.

In one aspect, the first part of the predicted beam report includes an explicit indication that the UE is to transmit the second part of the predicted beam report.

In one aspect, the first part of the predicted beam report includes an indication that the UE is to transmit the second part of the predicted beam report based at least in part on a total of one or more confidence levels that are indicated in the first part of the predicted beam report not satisfying a threshold.

In one aspect, the indication of the payload size of the second part of the predicted beam report includes an indication of a quantity of one or more predicted beams that are to be indicated in the second part of the predicted beam report.

In one aspect, the predicted beam report is configured on one or more PUSCH resources.

In one aspect, the beam report configuration configures a payload size of the second part of the predicted beam report.

In one aspect, transmitting the second part of the predicted beam report includes transmitting the second part of the predicted beam report based at least in part on a total of one or more confidence levels that are indicated in the first part of the predicted beam report not satisfying a threshold.

In one aspect, the beam report configuration includes an indication of a first priority associated with the first part of the predicted beam report, and an indication of a second priority associated with the second part of the predicted beam report, and transmitting the first part of the predicted beam report includes transmitting the first part of the predicted beam report in accordance with the first priority, and transmitting the second part of the predicted beam report includes transmitting the second part of the predicted beam report in accordance with the second priority.

In one aspect, method 1200 further includes receiving an indication of one or more priority rules that indicate how to resolve collisions, based at least in part on the first priority, between the first part of the predicted beam report and another report, or that indicate how to resolve collisions, based at least in part on the second priority, between the second part of the predicted beam report and the other report.

In one aspect, transmitting the first part of the predicted beam report includes transmitting the first part of the predicted beam report based at least in part on a first quantization table, and transmitting the second part of the predicted beam report includes transmitting the second part of the predicted beam report based at least in part on a second quantization table.

In one aspect, the first quantization table defines a first quantity of quantization bits, the second quantization table defines a second quantity of quantization bits, transmitting the first part of the predicted beam report includes transmitting the first part of the predicted beam report using the first quantity of quantization bits, and transmitting the second part of the predicted beam report includes transmitting the second part of the predicted beam report using the second quantity of quantization bits.

In one aspect, the beam report configuration is a first beam report configuration, the predicted beam report is a first predicted beam report, the at least one predicted beam is at least one first predicted beam, and the at least one confidence level is at least one first confidence level, and method 1200 further includes receiving a second beam report configuration, and transmitting, in accordance with the second beam report configuration, a second predicted beam report that includes an indication of at least one second predicted beam and an indication of at least one second confidence level that corresponds to the at least one second predicted beam, wherein transmitting the second predicted beam report includes transmitting the second predicted beam report based at least in part on the at least one second confidence level.

In one aspect, receiving the second beam report configuration includes receiving the second beam report configuration based at least in part on a total of one or more first confidence levels that are indicated in the first predicted beam report not satisfying a threshold.

In one aspect, the first beam report configuration configures a payload size of the first predicted beam report.

In one aspect, the first predicted beam report includes an indication of a payload size of the second predicted beam report.

In one aspect, the indication of the payload size of the second predicted beam report includes an indication of a quantity of the at least one second predicted beam.

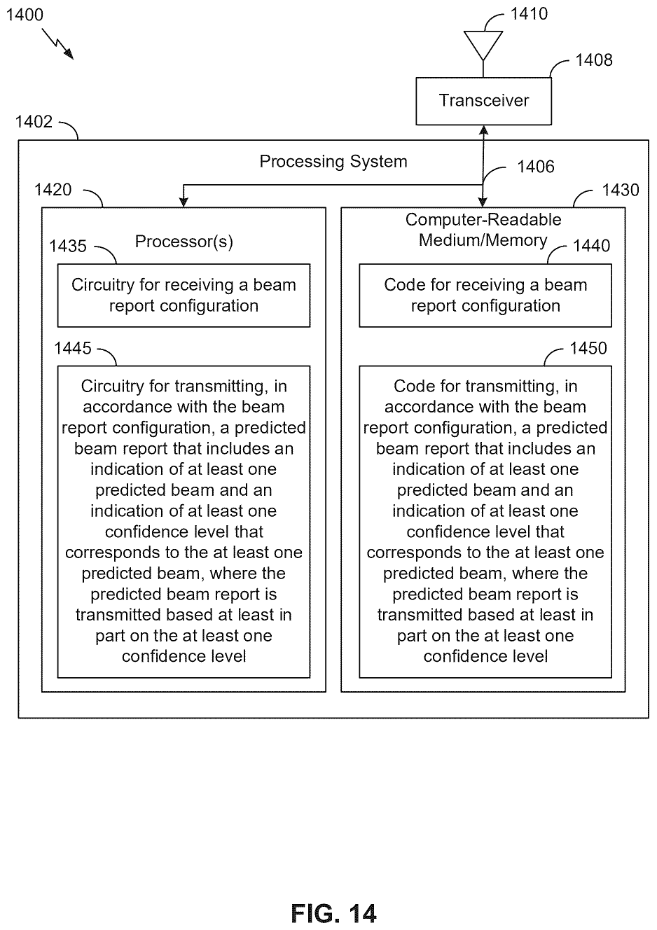

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

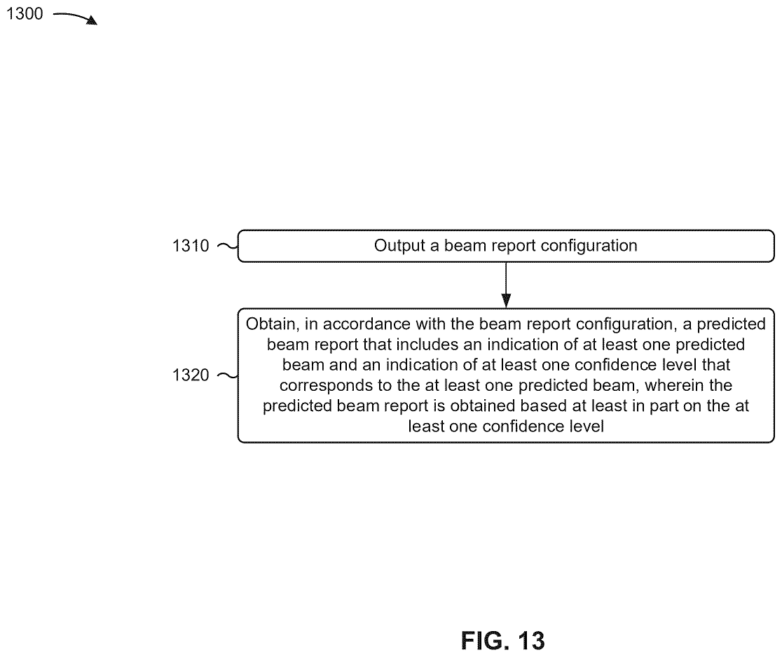

FIG. 13 shows a method 1300 for wireless communications by a network entity, such as BS 110, or a disaggregated base station as discussed with respect to FIG. 3.

Method 1300 begins at 1310 with outputting a beam report configuration.

Method 1300 then proceeds to step 1320 with obtaining, in accordance with the beam report configuration, a predicted beam report that includes an indication of at least one predicted beam and an indication of at least one confidence level that corresponds to the at least one predicted beam, wherein obtaining the predicted beam report includes obtaining the predicted beam report based at least in part on the at least one confidence level.

In one aspect, the confidence level indicates a probability that the at least one predicted beam will be selected from among one or more predicted beams.

In one aspect, a quantity of one or more predicted beams, including the at least one predicted beam, indicated in the predicted beam report is based at least in part on whether a total of one or more confidence levels, including the at least one confidence level, satisfies a threshold.

In one aspect, the threshold is configurable.

In one aspect, the beam report configuration includes an indication to report a first part of the predicted beam report via a first resource and a second part of the predicted beam report via a second resource, obtaining the predicted beam report includes obtaining the first part of the predicted beam report via the first resource, and obtaining the second part of the predicted beam report via the second resource.

In one aspect, the first part of the predicted beam report includes an indication of a payload size of the second part of the predicted beam report.

In one aspect, the beam report configuration configures a payload size of the first part of the predicted beam report.

In one aspect, the first part of the predicted beam report includes an explicit indication that the network entity is to obtain the second part of the predicted beam report.

In one aspect, the first part of the predicted beam report includes an indication that the network entity is to obtain the second part of the predicted beam report based at least in part on a total of one or more confidence levels that are indicated in the first part of the predicted beam report not satisfying a threshold.

In one aspect, the indication of the payload size of the second part of the predicted beam report includes an indication of a quantity of one or more predicted beams that are to be indicated in the second part of the predicted beam report.

In one aspect, the predicted beam report is configured on one or more PUSCH resources.

In one aspect, the beam report configuration configures a payload size of the second part of the predicted beam report.

In one aspect, obtaining the second part of the predicted beam report includes obtaining the second part of the predicted beam report based at least in part on a total of one or more confidence levels that are indicated in the first part of the predicted beam report not satisfying a threshold.

In one aspect, the beam report configuration includes an indication of a first priority associated with the first part of the predicted beam report, an indication of a second priority associated with the second part of the predicted beam report, obtaining the first part of the predicted beam report includes obtaining the first part of the predicted beam report in accordance with the first priority, and obtaining the second part of the predicted beam report includes obtaining the second part of the predicted beam report in accordance with the second priority.

In one aspect, method 1300 further includes outputting an indication of one or more priority rules that indicate how to resolve collisions, based at least in part on the first priority, between the first part of the predicted beam report and another report, or that indicate how to resolve collisions, based at least in part on the second priority, between the second part of the predicted beam report and the other report.

In one aspect, obtaining the first part of the predicted beam report includes obtaining the first part of the predicted beam report based at least in part on a first quantization table, and obtaining the second part of the predicted beam report includes obtaining the second part of the predicted beam report based at least in part on a second quantization table.

In one aspect, the first quantization table defines a first quantity of quantization bits, the second quantization table defines a second quantity of quantization bits, obtaining the first part of the predicted beam report includes obtaining the first part of the predicted beam report using the first quantity of quantization bits, and obtaining the second part of the predicted beam report includes obtaining the second part of the predicted beam report using the second quantity of quantization bits.

In one aspect, the beam report configuration is a first beam report configuration, the predicted beam report is a first predicted beam report, the at least one predicted beam is at least one first predicted beam, and the at least one confidence level is at least one first confidence level, the method 1300 further including outputting a second beam report configuration, and obtaining, in accordance with the second beam report configuration, a second predicted beam report that includes an indication of at least one second predicted beam and an indication of at least one second confidence level that corresponds to the at least one second predicted beam, wherein obtaining the second predicted beam report includes obtaining the second predicted beam report based at least in part on the at least one second confidence level.

In one aspect, outputting the second beam report configuration includes outputting the second beam report configuration based at least in part on a total of one or more first confidence levels that are indicated in the first predicted beam report not satisfying a threshold.

In one aspect, the first beam report configuration configures a payload size of the first predicted beam report.

In one aspect, the first predicted beam report includes an indication of a payload size of the second predicted beam report.

In one aspect, the indication of the payload size of the second predicted beam report includes an indication of a quantity of the at least one second predicted beam.

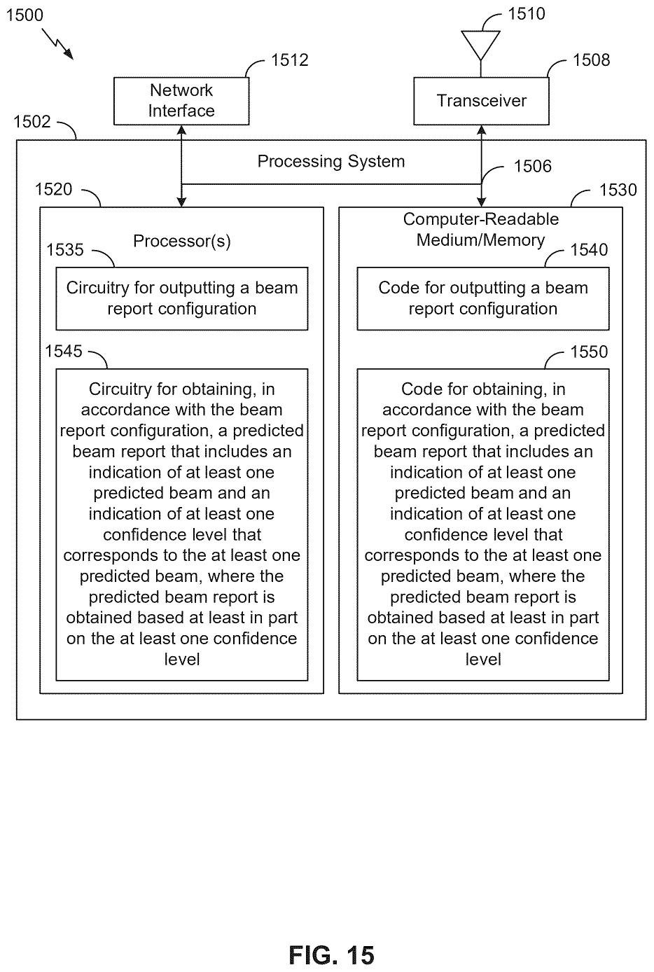

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

FIG. 14 is a diagram illustrating an example of an implementation of code and circuitry for a communications device 1400, in accordance with the present disclosure. The communications device 1400 may be a UE, or a UE may include the communications device 1400.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of one or more of receive processor 258, transmit processor 264, TX MIMO processor 266, and/or controller/processor 280, as described with respect to FIG. 2. The one or more processors 1420 are coupled to a computer-readable medium/memory 1430 via a bus 1406. In various aspects, the computer-readable medium/memory 1430 may be representative of memory 282, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the method 1200 described with respect to FIG. 12, or any aspect related to it. Note that reference to a processor performing a function of communications device 1400 may include one or more processors performing that function of communications device 1400.

As shown in FIG. 14, the communications device 1400 may include circuitry for receiving a beam report configuration (circuitry 1435).

As shown in FIG. 14, the communications device 1400 may include, stored in computer-readable medium/memory 1430, code for receiving a beam report configuration (code 1440).

As shown in FIG. 14, the communications device 1400 may include circuitry for transmitting, in accordance with the beam report configuration, a predicted beam report that includes an indication of at least one predicted beam and an indication of at least one confidence level that corresponds to the at least one predicted beam, wherein transmitting the predicted beam report includes transmitting the predicted beam report based at least in part on the at least one confidence level (circuitry 1445).

As shown in FIG. 14, the communications device 1400 may include, stored in computer-readable medium/memory 1430, code for transmitting, in accordance with the beam report configuration, a predicted beam report that includes an indication of at least one predicted beam and an indication of at least one confidence level that corresponds to the at least one predicted beam, wherein transmitting the predicted beam report includes transmitting the predicted beam report based at least in part on the at least one confidence level (code 1450).

Various components of the communications device 1400 may provide means for performing the method 1200 described with respect to FIG. 12, or any aspect related to it. For example, means for transmitting, sending, or outputting for transmission may include the transceiver(s) 254 and/or antenna(s) 252 of the UE 120 and/or transceiver 1408 and antenna 1410 of the communications device 1400 in FIG. 14. Means for receiving or obtaining may include the transceiver(s) 254 and/or antenna(s) 252 of the UE 120 and/or transceiver 1408 and antenna 1410 of the communications device 1400 in FIG. 14.

FIG. 14 is provided as an example. Other examples may differ from what is described in connection with FIG. 14.

FIG. 15 is a diagram illustrating an example of an implementation of code and circuitry for a communications device 1500, in accordance with the present disclosure. The communications device 1500 may be a network entity (such as BS 110 or a disaggregated base station as described with regard to FIG. 3), or a network entity may include the communications device 1500.

The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The network interface 1512 is configured to obtain and send signals for the communications device 1500 via communications link(s), such as a backhaul link, midhaul link, and/or fronthaul link as described herein, such as with respect to FIG. 3. The processing system 1502 may be configured to perform processing functions for the communications device 1500, including processing signals received and/or to be transmitted by the communications device 1500.

The processing system 1502 includes one or more processors 1520. In various aspects, the one or more processors 1520 may be representative of one or more of receive processor 238, transmit processor 220, TX MIMO processor 230, and/or controller/processor 240, as described with respect to FIG. 2. The one or more processors 1520 are coupled to a computer-readable medium/memory 1530 via a bus 1506. In various aspects, the computer-readable medium/memory 1530 may be representative of memory 242, as described with respect to FIG. 2. In certain aspects, the computer-readable medium/memory 1530 is configured to store instructions (e.g., computer-executable code, processor-executable code) that when executed by the one or more processors 1520, cause the one or more processors 1520 to perform the method 1300 described with respect to FIG. 13, or any aspect related to it. Note that reference to a processor performing a function of communications device 1500 may include one or more processors performing that function of communications device 1500.

As shown in FIG. 15, the communications device 1500 may include circuitry for outputting a beam report configuration (circuitry 1535).

As shown in FIG. 15, the communications device 1500 may include, stored in computer-readable medium/memory 1530, code for outputting a beam report configuration (code 1540).

As shown in FIG. 15, the communications device 1500 may include circuitry for obtaining, in accordance with the configuration, a predicted beam report that includes an indication of at least one predicted beam and an indication of at least one confidence level that corresponds to the at least one predicted beam, wherein obtaining the predicted beam report includes obtaining the predicted beam report based at least in part on the at least one confidence level (circuitry 1545).

As shown in FIG. 15, the communications device 1500 may include, stored in computer-readable medium/memory 1530, code for obtaining, in accordance with the configuration, a predicted beam report that includes an indication of at least one predicted beam and an indication of at least one confidence level that corresponds to the at least one predicted beam, wherein obtaining the predicted beam report includes obtaining the predicted beam report based at least in part on the at least one confidence level (code 1550).

Various components of the communications device 1500 may provide means for performing the method 1300 described with respect to FIG. 13, or any aspect related to it. For example, means for transmitting, sending, or outputting for transmission may include the transceiver(s) 232 and/or antenna(s) 234 of the BS 110 and/or transceiver 1508 and antenna 1510 of the communications device 1500 in FIG. 15. Means for receiving or obtaining may include the transceiver(s) 232 and/or antenna(s) 234 of the BS 110 and/or transceiver 1508 and antenna 1510 of the communications device 1500 in FIG. 15.

FIG. 15 is provided as an example. Other examples may differ from what is described in connection with FIG. 15.

The following provides an overview of some Aspects of the present disclosure:

Aspect 1: A method of wireless communication performed by a UE, comprising: receiving a beam report configuration; and transmitting, in accordance with the beam report configuration, a predicted beam report that includes an indication of at least one predicted beam and an indication of at least one confidence level that corresponds to the at least one predicted beam, wherein transmitting the predicted beam report includes transmitting the predicted beam report based at least in part on the at least one confidence level.

Aspect 2: The method of Aspect 1, wherein the confidence level indicates a probability that the at least one predicted beam will be selected from among one or more predicted beams.

Aspect 3: The method of any of Aspects 1-2, wherein a quantity of one or more predicted beams, including the at least one predicted beam, indicated in the predicted beam report is based at least in part on whether a total of one or more confidence levels, including the at least one confidence level, satisfies a threshold.

Aspect 4: The method of Aspect 3, wherein the threshold is configurable.

Aspect 5: The method of any of Aspects 1-4, wherein the beam report configuration configures the UE to report a first part of the predicted beam report via a first resource and a second part of the predicted beam report via a second resource, and wherein transmitting the predicted beam report includes: transmitting the first part of the predicted beam report via the first resource; and transmitting the second part of the predicted beam report via the second resource.

Aspect 6: The method of Aspect 5, wherein the first part of the predicted beam report includes an indication of a payload size of the second part of the predicted beam report.

Aspect 7: The method of Aspect 6, wherein the beam report configuration configures a payload size of the first part of the predicted beam report.

Aspect 8: The method of Aspect 6, wherein the first part of the predicted beam report includes an explicit indication that the UE is to transmit the second part of the predicted beam report.

Aspect 9: The method of Aspect 6, wherein the first part of the predicted beam report includes an indication that the UE is to transmit the second part of the predicted beam report based at least in part on a total of one or more confidence levels that are indicated in the first part of the predicted beam report not satisfying a threshold.

Aspect 10: The method of Aspect 6, wherein the indication of the payload size of the second part of the predicted beam report includes an indication of a quantity of one or more predicted beams that are to be indicated in the second part of the predicted beam report.

Aspect 11: The method of Aspect 6, wherein the predicted beam report is configured on one or more PUSCH resources.

Aspect 12: The method of Aspect 5, wherein the beam report configuration configures a payload size of the second part of the predicted beam report.

Aspect 13: The method of Aspect 5, wherein transmitting the second part of the predicted beam report includes: transmitting the second part of the predicted beam report based at least in part on a total of one or more confidence levels that are indicated in the first part of the predicted beam report not satisfying a threshold.

Aspect 14: The method of Aspect 5, wherein the beam report configuration includes an indication of a first priority associated with the first part of the predicted beam report, and an indication of a second priority associated with the second part of the predicted beam report, and wherein: transmitting the first part of the predicted beam report includes transmitting the first part of the predicted beam report in accordance with the first priority; and transmitting the second part of the predicted beam report includes transmitting the second part of the predicted beam report in accordance with the second priority.

Aspect 15: The method of Aspect 14, further comprising: receiving an indication of one or more priority rules that indicate how to resolve collisions, based at least in part on the first priority, between the first part of the predicted beam report and another report, or that indicate how to resolve collisions, based at least in part on the second priority, between the second part of the predicted beam report and the other report.

Aspect 16: The method of Aspect 5, wherein: transmitting the first part of the predicted beam report includes transmitting the first part of the predicted beam report based at least in part on a first quantization table; and transmitting the second part of the predicted beam report includes transmitting the second part of the predicted beam report based at least in part on a second quantization table.

Aspect 17: The method of Aspect 16, wherein the first quantization table defines a first quantity of quantization bits, and the second quantization table defines a second quantity of quantization bits, and wherein: transmitting the first part of the predicted beam report includes transmitting the first part of the predicted beam report using the first quantity of quantization bits; and transmitting the second part of the predicted beam report includes transmitting the second part of the predicted beam report using the second quantity of quantization bits.

Aspect 18: The method of any of Aspects 1-17, wherein the beam report configuration is a first beam report configuration, the predicted beam report is a first predicted beam report, the at least one predicted beam is at least one first predicted beam, and the at least one confidence level is at least one first confidence level, the method further comprising: receiving a second beam report configuration; and transmitting, in accordance with the second beam report configuration, a second predicted beam report that includes an indication of at least one second predicted beam and an indication of at least one second confidence level that corresponds to the at least one second predicted beam, wherein transmitting the second predicted beam report includes transmitting the second predicted beam report based at least in part on the at least one second confidence level.

Aspect 19: The method of Aspect 18, wherein receiving the second beam report configuration includes: receiving the second beam report configuration based at least in part on a total of one or more first confidence levels that are indicated in the first predicted beam report not satisfying a threshold.

Aspect 20: The method of Aspect 18, wherein the first beam report configuration configures a payload size of the first predicted beam report.

Aspect 21: The method of Aspect 18, wherein the first predicted beam report includes an indication of a payload size of the second predicted beam report.

Aspect 22: The method of Aspect 21, wherein the indication of the payload size of the second predicted beam report includes an indication of a quantity of the at least one second predicted beam.

Aspect 23: A method of wireless communication performed by a network entity, comprising: outputting a beam report configuration; and obtaining, in accordance with the beam report configuration, a predicted beam report that includes an indication of at least one predicted beam and an indication of at least one confidence level that corresponds to the at least one predicted beam, wherein obtaining the predicted beam report includes obtaining the predicted beam report based at least in part on the at least one confidence level.

Aspect 24: The method of Aspect 23, wherein the confidence level indicates a probability that the at least one predicted beam will be selected from among one or more predicted beams.

Aspect 25: The method of any of Aspects 23-24, wherein a quantity of one or more predicted beams, including the at least one predicted beam, indicated in the predicted beam report is based at least in part on whether a total of one or more confidence levels, including the at least one confidence level, satisfies a threshold.

Aspect 26: The method of Aspect 25, wherein the threshold is configurable.

Aspect 27: The method of any of Aspects 23-26, wherein the beam report configuration includes an indication to report a first part of the predicted beam report via a first resource and a second part of the predicted beam report via a second resource, and wherein obtaining the predicted beam report includes: obtaining the first part of the predicted beam report via the first resource; and obtaining the second part of the predicted beam report via the second resource.

Aspect 28: The method of Aspect 27, wherein the first part of the predicted beam report includes an indication of a payload size of the second part of the predicted beam report.

Aspect 29: The method of Aspect 28, wherein the beam report configuration configures a payload size of the first part of the predicted beam report.

Aspect 30: The method of Aspect 28, wherein the first part of the predicted beam report includes an explicit indication that the network entity is to obtain the second part of the predicted beam report.

Aspect 31: The method of Aspect 28, wherein the first part of the predicted beam report includes an indication that the network entity is to obtain the second part of the predicted beam report based at least in part on a total of one or more confidence levels that are indicated in the first part of the predicted beam report not satisfying a threshold.

Aspect 32: The method of Aspect 28, wherein the indication of the payload size of the second part of the predicted beam report includes an indication of a quantity of one or more predicted beams that are to be indicated in the second part of the predicted beam report.

Aspect 33: The method of Aspect 28, wherein the predicted beam report is configured on one or more PUSCH resources.

Aspect 34: The method of Aspect 27, wherein the beam report configuration configures a payload size of the second part of the predicted beam report.

Aspect 35: The method of Aspect 27, wherein obtaining the second part of the predicted beam report includes: obtaining the second part of the predicted beam report based at least in part on a total of one or more confidence levels that are indicated in the first part of the predicted beam report not satisfying a threshold.

Aspect 36: The method of Aspect 27, wherein the beam report configuration includes an indication of a first priority associated with the first part of the predicted beam report, and an indication of a second priority associated with the second part of the predicted beam report, and wherein: obtaining the first part of the predicted beam report includes obtaining the first part of the predicted beam report in accordance with the first priority; and obtaining the second part of the predicted beam report includes obtaining the second part of the predicted beam report in accordance with the second priority.

Aspect 37: The method of Aspect 36, further comprising: outputting an indication of one or more priority rules that indicate how to resolve collisions, based at least in part on the first priority, between the first part of the predicted beam report and another report, or that indicate how to resolve collisions, based at least in part on the second priority, between the second part of the predicted beam report and the other report.

Aspect 38: The method of Aspect 27, wherein: obtaining the first part of the predicted beam report includes obtaining the first part of the predicted beam report based at least in part on a first quantization table; and obtaining the second part of the predicted beam report includes obtaining the second part of the predicted beam report based at least in part on a second quantization table.

Aspect 39: The method of Aspect 38, wherein the first quantization table defines a first quantity of quantization bits, and the second quantization table defines a second quantity of quantization bits, and wherein: obtaining the first part of the predicted beam report includes obtaining the first part of the predicted beam report using the first quantity of quantization bits; and obtaining the second part of the predicted beam report includes obtaining the second part of the predicted beam report using the second quantity of quantization bits.

Aspect 40: The method of any of Aspects 23-39, wherein the beam report configuration is a first beam report configuration, the predicted beam report is a first predicted beam report, the at least one predicted beam is at least one first predicted beam, and the at least one confidence level is at least one first confidence level, the method further comprising: outputting a second beam report configuration; and obtaining, in accordance with the second beam report configuration, a second predicted beam report that includes an indication of at least one second predicted beam and an indication of at least one second confidence level that corresponds to the at least one second predicted beam, wherein obtaining the second predicted beam report includes obtaining the second predicted beam report based at least in part on the at least one second confidence level.

Aspect 41: The method of Aspect 40, wherein outputting the second beam report configuration includes: outputting the second beam report configuration based at least in part on a total of one or more first confidence levels that are indicated in the first predicted beam report not satisfying a threshold.

Aspect 42: The method of Aspect 40, wherein the first beam report configuration configures a payload size of the first predicted beam report.

Aspect 43: The method of Aspect 40, wherein the first predicted beam report includes an indication of a payload size of the second predicted beam report.

Aspect 44: The method of Aspect 43, wherein the indication of the payload size of the second predicted beam report includes an indication of a quantity of the at least one second predicted beam.

Aspect 45: An apparatus for wireless communication at a device, comprising a processor; memory coupled with the processor; and instructions stored in the memory and executable by the processor to cause the apparatus to perform the method of one or more of Aspects 1-44.

Aspect 46: A device for wireless communication, comprising a memory and one or more processors coupled to the memory, the one or more processors configured to perform the method of one or more of Aspects 1-44.

Aspect 47: An apparatus for wireless communication, comprising at least one means for performing the method of one or more of Aspects 1-44.

Aspect 48: A non-transitory computer-readable medium storing code for wireless communication, the code comprising instructions executable by a processor to perform the method of one or more of Aspects 1-44.

Aspect 49: A non-transitory computer-readable medium storing a set of instructions for wireless communication, the set of instructions comprising one or more instructions that, when executed by one or more processors of a device, cause the device to perform the method of one or more of Aspects 1-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) for wireless communication, comprising:
a memory; and
one or more processors, coupled to the memory, configured to:
receive a beam report configuration; and
transmit, in accordance with the beam report configuration, a predicted beam report that includes an indication of at least one predicted beam and an indication of at least one confidence level that corresponds to the at least one predicted beam,
wherein the one or more processors, to transmit the predicted beam report, are configured to transmit the predicted beam report based at least in part on the at least one confidence level.

2. The UE of claim 1, wherein the confidence level indicates a probability that the at least one predicted beam will be selected from among one or more predicted beams.

3. The UE of claim 1, wherein a quantity of one or more predicted beams, including the at least one predicted beam, indicated in the predicted beam report is based at least in part on whether a total of one or more confidence levels, including the at least one confidence level, satisfies a threshold.

4. (canceled)

5. The UE of claim 1, wherein the beam report configuration configures the UE to report a first part of the predicted beam report via a first resource and a second part of the predicted beam report via a second resource, and wherein the one or more processors, to transmit the predicted beam report, are configured to:
transmit the first part of the predicted beam report via the first resource; and
transmit the second part of the predicted beam report via the second resource.

6. The UE of claim 5, wherein the first part of the predicted beam report includes an indication of a payload size of the second part of the predicted beam report.

7. The UE of claim 6, wherein the beam report configuration configures a payload size of the first part of the predicted beam report.

8. The UE of claim 6, wherein:
the first part of the predicted beam report includes an explicit indication that the UE is to transmit the second part of the predicted beam report; or
the first part of the predicted beam report includes an indication that the UE is to transmit the second part of the predicted beam report based at least in part on a total of one or more confidence levels that are indicated in the first part of the predicted beam report not satisfying a threshold.

9. (canceled)

10. The UE of claim 6, wherein the indication of the payload size of the second part of the predicted beam report includes an indication of a quantity of one or more predicted beams that are to be indicated in the second part of the predicted beam report.

11. The UE of claim 6, wherein the predicted beam report is configured on one or more physical uplink shared channel resources.

12. The UE of claim 5, wherein the beam report configuration configures a payload size of the second part of the predicted beam report.

13. The UE of claim 5, wherein the one or more processors, to transmit the second part of the predicted beam report, are configured to:
transmit the second part of the predicted beam report based at least in part on a total of one or more confidence levels that are indicated in the first part of the predicted beam report not satisfying a threshold.

14. The UE of claim 5, wherein the beam report configuration includes an indication of a first priority associated with the first part of the predicted beam report, and an indication of a second priority associated with the second part of the predicted beam report, and wherein the one or more processors, to transmit the second part of the predicted beam report, are configured to:
transmit the first part of the predicted beam report in accordance with the first priority; and
transmit the second part of the predicted beam report in accordance with the second priority,
wherein the one or more processors are further configured to: receive an indication of one or more priority rules that indicate how to resolve collisions, based at least in part on the first priority, between the first part of the predicted beam report and another report, or that indicate how to resolve collisions, based at least in part on the second priority, between the second part of the predicted beam report and the other report.

15. (canceled)

16. The UE of claim 5, wherein the one or more processors, to transmit the second part of the predicted beam report, are configured to:
transmit the first part of the predicted beam report based at least in part on a first quantization table; and
transmit the second part of the predicted beam report based at least in part on a second quantization table,
wherein the first quantization table defines a first quantity of quantization bits, and the second quantization table defines a second quantity of quantization bits, and wherein the one or more processors, to transmit the second part of the predicted beam report, are configured to:
transmit the first part of the predicted beam report using the first quantity of quantization bits; and
transmit the second part of the predicted beam report using the second quantity of quantization bits.

17. (canceled)

18. The UE of claim 1, wherein the beam report configuration is a first beam report configuration, the predicted beam report is a first predicted beam report, the at least one predicted beam is at least one first predicted beam, and the at least one confidence level is at least one first confidence level, and wherein the one or more processors are further configured to:
receive a second beam report configuration; and
transmit, in accordance with the second beam report configuration, a second predicted beam report that includes an indication of at least one second predicted beam and an indication of at least one second confidence level that corresponds to the at least one second predicted beam,
wherein the one or more processors, to transmit the second predicted beam report, are configured to transmit the second predicted beam report based at least in part on the at least one second confidence level.

19. The UE of claim 18, wherein the one or more processors, to receive the second beam report configuration, are configured to:
receive the second beam report configuration based at least in part on a total of one or more first confidence levels that are indicated in the first predicted beam report not satisfying a threshold.

20. The UE of claim 18, wherein the first beam report configuration configures a payload size of the first predicted beam report.

21. The UE of claim 18, wherein the first predicted beam report includes an indication of a payload size of the second predicted beam report.

22. The UE of claim 21, wherein the indication of the payload size of the second predicted beam report includes an indication of a quantity of the at least one second predicted beam.

23. A network entity for wireless communication, comprising:
a memory; and
one or more processors, coupled to the memory, configured to:
output a beam report configuration; and
obtain, in accordance with the beam report configuration, a predicted beam report that includes an indication of at least one predicted beam and an indication of at least one confidence level that corresponds to the at least one predicted beam,
wherein the one or more processors, to obtain the predicted beam report, are configured to obtain the predicted beam report based at least in part on the at least one confidence level.

24-28. (canceled)

29. A method of wireless communication performed by a user equipment (UE), comprising:
receiving a beam report configuration; and
transmitting, in accordance with the beam report configuration, a predicted beam report that includes an indication of at least one predicted beam and an indication of at least one confidence level that corresponds to the at least one predicted beam,
wherein transmitting the predicted beam report includes transmitting the predicted beam report based at least in part on the at least one confidence level.

30. (canceled)
